(19) United States
(12) Patent Application Publication
(10) Pub. No.: US 2010/0131552 A1
(43) Pub. Date: May 27, 2010

(54) METHOD, PROCESSING APPARATUS, AND COMPUTER READABLE MEDIUM FOR RESTRICTING INPUT IN ASSOCIATION WITH A DATABASE

(75) Inventor: Seung Phill LIM, Yongin-si (KR)

Correspondence Address: H.C. PARK & ASSOCIATES, PLC, 8500 LEESBURG PIKE, SUITE 7500, VIENNA, VA, 22182, US

(73) Assignee: NHN Corporation, Seongnam-si (KR)

(21) Appl. No.: 12/625,158

(22) Filed: Nov. 24, 2009

(30) Foreign Application Priority Data
Nov. 27, 2008 (KR) 10-2008-0119143

(51) Int. Cl. G06F 17/30

(52) U.S. Cl. 707/769; 707/781; 707/E17.014; 340/815.4; 340/384.1; 345/173

(57) ABSTRACT

Disclosed is a method, processing apparatus, and computer readable recording medium for restricting input in association with a database. According to an exemplary embodiment of the present invention, there is provided a method of restricting input in association with a database, including searching a database for information that includes inputted data; and restricting input of subsequent data that is not included in the information in the database that includes the inputted data, wherein the inputted data includes at least one grapheme. According to the present invention, input of incorrect information that is probable to be inputted is restricted when the information is inputted through an input interface of a terminal, and the restriction is applied to Korean characters, English letters, special characters, numerals and the like, whereby input of correct information is induced from all aspects of characters.

### CROSS REFERENCE TO RELATED APPLICATION

This application claims priority from and the benefit of Korean Patent Application No. 10-2008-0119143, filed on Nov. 27, 2008, which is hereby incorporated by reference for all purposes as if fully set forth herein.

### BACKGROUND OF THE INVENTION

1. Field of the Invention

Exemplary embodiments of the present invention relate to a method, processing apparatus and computer readable recording medium for restricting input in association with a database, and more specifically, to a method, processing apparatus and computer readable recording medium for restricting input in association with a database, in which the database is searched in real-time for information that includes data inputted up to the present by a user using a terminal device and in which input of information that does not correspond to information stored in the database is restricted, thereby preventing incorrect input.

2. Discussion of the Background

Recently, in accordance with the trend of miniaturizing mobile terminals and implementing user-oriented interfaces, various input interface techniques for inputting information at a terminal have been developed. Particularly, input interface techniques based on a touch screen are widely distributed, and development of these input interface techniques is continuously progressing. Generally, a touch screen is an apparatus in which a touch panel capable of sensing a user's touch is included in a display such as a liquid crystal display (LCD) so that a user may perform a desired function. Since such a touch screen allows a user to perform a desired function without an additional input means such as a keyboard or a keypad, it is used in a small-sized terminal (e.g., a cellular phone, an MP3 player, or a navigator) that is limited in space compared with other apparatuses.

In general, a terminal provided with a touch screen includes a monitor as a display unit, a touch panel attached to the monitor, a control unit for controlling a variety of application programs installed in the terminal according to a signal sensed in the touch panel, and one or more devices for performing various operations under the control of the control unit. The touch panel is typically configured to have several layers including specially processed electrode glass (ITO glass) and electrode film (ITO film) and recognizes a touch point as a coordinate value when a hand, a pen, or the like touches the surface of the touch panel. The control unit receives a position signal corresponding to the recognized coordinate value and controls the devices to process a corresponding function.

As trends continue toward miniaturization of terminals, the area allocated to an input interface of a touch screen or a general key input unit included in a terminal is also reduced in size. Accordingly, if a user does not use a pointed tool (e.g., a stylus pen used when inputting information through a touch screen) when the user inputs desired information through the input interface, various kinds of input errors may occur. For example, when the user inputs character information, an input error may occur by selecting a key neighboring a desired key by mistake. If such an input error occurs, the user suffers from the inconvenience of deleting the character information inputted by the user and re-inputting correct character information.

Such a problem may occur when information is inputted through a general keyboard as well as a touch screen, however, where a keyboard is used, frequency of input errors is lower as compared with the case where a touch screen is used. Additionally, when a user inputs a keyword that he or she does not know how to spell correctly, it is difficult to figure out in real time whether the keyword has been correctly inputted. Therefore, there is a problem in that if the keyword is confirmed to be an item that is not stored in the database after the keyword is completely inputted, the user must re-input a correct keyword through trial and error.

Accordingly, a way to minimize a user's input errors and induce input of correct information when a user inputs information through a terminal having a variety of input interfaces will be beneficial.

### SUMMARY OF THE INVENTION

Exemplary embodiments of the present invention provide a way to guide a user to input effective information by searching a database based on data inputted up to the present and restricting input of subsequent data that is not stored in the database and is probable to be inputted when the user inputs the information through a touch screen, a keyboard, or the like included in a terminal device.

Exemplary embodiments of the present invention also provide a way to induce correct input from all aspects of characters by applying the present invention to inputs including, for example, numerals, Korean characters, English letters, special characters, and the like, in restricting input of subsequent data that is not stored in the database and is probable to be inputted when a user inputs the information through a terminal device.

Additional features of the invention will be set forth in the description which follows, and in part will be apparent from the description, or may be learned by practice of the invention.

An exemplary embodiment of the present invention discloses a method of restricting input in association with a database, including searching a database for information that includes inputted data, and restricting input of subsequent data that is not included in the information in the database that includes the inputted data, wherein the inputted data includes at least one grapheme.

An exemplary embodiment of the present invention also discloses a processing apparatus for restricting input in association with a database, including an input data acquisition unit to acquire inputted data, and an input restriction unit to search a database for information that includes the inputted data and to restrict input of subsequent data that is not included in the information in the database that includes the inputted data, wherein the inputted data comprises at least one grapheme.

An exemplary embodiment of the present invention also discloses a non-transitory computer-readable medium including an executable program which, when executed, performs the steps of searching a database for information that includes inputted data, and restricting input of subsequent data that is not included in the information in the database that includes the inputted data, wherein the inputted data includes at least one grapheme.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a view showing the configuration of a terminal for inducing input of correct information when the information is inputted through an input means according to an exemplary embodiment of the present invention.

FIG. 2 is a view showing the detailed internal configuration of a touch screen driving unit 110 according to an exemplary embodiment of the present invention.

FIG. 3 is a view showing an example of using a touch screen installed in a terminal according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It is to be understood that the various exemplary embodiments of the invention, although different from each other, are not necessarily mutually exclusive. For example, specific configurations, structures, and features described herein, in connection with one exemplary embodiment, may be implemented within other embodiments without departing from the spirit and scope of the invention. In addition, it is to be understood that the location or arrangement of individual elements within each disclosed exemplary embodiment may be modified without departing from the spirit and scope of the invention. The following detailed description is, therefore, not to be used for the purpose of limitation, and the scope of the present invention is defined only by the appended claims, appropriately interpreted, along with the full range of equivalents to which the claims are entitled.

In the specification and claims, the term ‘terminal’ means a digital device capable of wired and wireless communication, and refers to a digital device, which includes memory and a microprocessor, and which has an operating ability, such as a personal computer (e.g., a desktop computer, a notebook computer, or the like), workstation, PDA, web pad, cellular phone, navigator, and the like. Although a digital device having a touch screen is described as an example in some parts of the specification and claims, the present invention is not necessarily limited thereto.

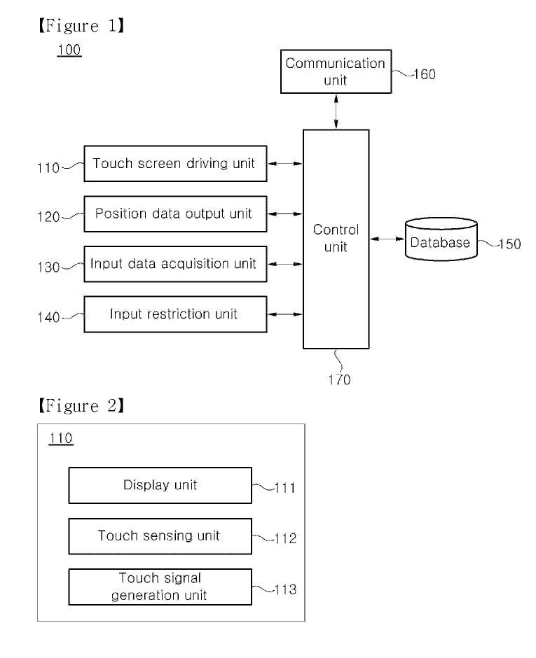

FIG. 1 is a view showing the configuration of a terminal 100 for restricting input in association with a database 150 according to an exemplary embodiment.

As shown in FIG. 1, a terminal 100 of an exemplary embodiment may comprise a touch screen driving unit 110, a position data output unit 120, an input data acquisition unit 130, an input restriction unit 140, a database 150, a communication unit 160, and a control unit 170. According to an exemplary embodiment, the touch screen driving unit 110, the position data output unit 120, the input data acquisition unit 130, the input restriction unit 140, the database 150, the communication unit 160, and the control unit 170 may include program modules provided in the terminal 100. Such program modules may be installed in the terminal 100 in the form of an operating system, an application program module, or other program modules and physically stored in a variety of commonly known memory devices. In addition, such program modules may be stored in a remote memory device that can communicate with the terminal 100. Although such program modules may include routines, subroutines, programs, objects, components, data structures and the like for performing a specific task as described below or executing a specific data type, they are not limited thereto.

The touch screen driving unit 110, according to an exemplary embodiment, will be described with reference to FIG. 2. The touch screen driving unit 110 operates a touch screen of the terminal 100 and generates an electrical signal corresponding to a touch when the touch is sensed on the touch screen.

Referring to FIG. 2, the touch screen driving unit 110 may comprise a display unit 111, a touch sensing unit 112, and a touch signal generation unit 113.

The display unit 111 may display, for example, state information generated while the terminal 100 is operating, multimedia information, and/or key buttons. The display unit 111 may be implemented as a commonly known display means, such as a liquid crystal display (LCD).

The touch sensing unit 112 may sense a touch when the touch occurs on a key button or the like of the display unit 111. The touch may occur in a variety of ways, including, for example, use of a stylus pen, a finger, or the like.

If the touch sensing unit 112 senses a touch, a corresponding sensing signal is transferred to the control unit 170, and the control unit 170 drives the touch signal generation unit 113 to generate an electrical signal corresponding to the touch. That is, the touch signal generation unit 113, according to an exemplary embodiment, serves to generate an electrical signal corresponding to a touch sensed by the touch sensing unit 112.

The position data output unit 120 according to an exemplary embodiment analyzes the electrical signal generated by the touch signal generation unit 113 and then outputs position data corresponding to the touch point. That is, the position data output unit 120 outputs position data corresponding to an element or region, such as, for example, a key positioned at the touch point of the displayed keypad. Although the position data may be expressed as coordinate value information corresponding to the touch point, it is apparent that the present invention is not limited thereto.

The input data acquisition unit 130, according to an exemplary embodiment, acquires corresponding input data referring to the position data outputted by the position data output unit 120. The input data acquired by the input data acquisition unit 130 may be temporarily stored in a memory before the information corresponding to the input data is displayed on the display unit 111.

The input restriction unit 140, according to an exemplary embodiment, may search the database 150 for information that includes data currently inputted by a user and may activate only the keys that are probable to be successively inputted immediately next based on the searched information. That is, the input restriction unit 140 may inactivate the keys that a user may incorrectly select as the next data input, based on the information contained within the database 150.

According to an exemplary embodiment, when a user inputs English letter information, the input restriction unit 140 inactivates the key(s) corresponding to a grapheme that is probable to form character information that is not in the database 150 as a next grapheme input. For example, in a state where a user inputs up to ‘San Francisco’ using the keypad displayed on the touch screen, if ‘San Francisco department store’, ‘San Francisco shoes shop’, ‘San Francisco pharmacy’ and ‘San Francisco junior high school’ are stored in the database 150 as information containing ‘San Francisco’, the input restriction unit 140 activates only the keys corresponding to ‘d’, ‘j’, ‘p’, and ‘s’ for the next input, referring to the database 150, and inactivates the other keys.

In addition, according to an exemplary embodiment, a user may input information by using only initial letters. For example, the user may input desired information using only initial letters by activating an ‘acronym mode’ or the like when the user inputs information using a keypad. Even in this case, the input restriction unit 140 inactivates the keys irrelevant for the next input by filtering the database 150 based on the initial letters inputted up to the present by the user. For example, when the user activates the acronym mode and inputs ‘n j m’ and only ‘New Jersey medical center’ exists in the database 150 as information corresponding to the initial letter information of ‘n j m’, the input restriction unit 140 may inactivate the keys except a key corresponding to ‘c’ with reference to ‘n j m’, which is the initial letter information of ‘New Jersey medical center’.

Although inputting English letters has been described above as an example of inputting characters, it is apparent that the present invention can be similarly applied to inputting Japanese letters, letters of other languages, and special characters such as, for example, a heart or asterisk, and the like.

According to an exemplary embodiment, a user may input numeral information such as a phone number and the like using a keypad displayed on the touch screen. Also in this case, the input restriction unit 140 may inactivate keys of the numerals and characters that are not in the database 150 among the numerals and characters that are probable to be successively inputted next with reference to the database 150. For example, if the user inputs up to ‘02-367-23’ and the database 150 stores information on phone numbers such as ‘02-367-2334’, ‘02-367-2349’, and ‘02-367-2397, the input restriction unit 140 inactivates numeric keys other than ‘3’, ‘4’, and ‘9’.

In addition, according to an exemplary embodiment, the input restriction unit 140 may perform the aforementioned operations only when the database 150 stores n (where n is an integer) or less pieces of information that includes data inputted up to the present by the user. For example, if n is set to 10 and the database 150 stores 11 pieces of information that include the data currently inputted by the user, the input restriction unit 140 activates all the keys of the keypad. This is to actively induce user's correct key input when the user is highly probable to input incorrect information as the next input, i.e., when most of the keys included in the keypad lead to incorrect input as the next input, whereas this is to allow the user to input a wide range of data by activating all the keys when most of the keys included in the keypad can be used to input correct information as the next input.

In addition, according to an exemplary embodiment, when a certain key is inactivated by the operation of the input restriction unit 140, there may be provided an indication for informing a user of a touch on the inactivated key. The indication may be a warning sound, a warning message or the like for informing the user that a touch is sensed on the inactivated key.

The database 150, according to an exemplary embodiment, may store information that can be inputted by the user through the keypad displayed on the touch screen. For example, if the terminal 100 is a navigator, the database 150 may store information on names of all districts, or cities. The information stored in the database 150 is preferably updated at regular intervals to be kept up-to-date. In addition, the information stored in the database 150 may be indexed based on a certain criterion. For example, the information may be indexed alphabetically, or based on categories.

Although the database 150 is shown as a component of the terminal 100 in FIG. 1, the database 150 may be a component that is separate from the terminal 100. For example, the database 150 may be a remote memory device capable of communicating with the terminal 100 or a physical storage medium such as a hard disk, a floppy disk, or a magnetic tape. If the database 150 is a remote memory device capable of communicating with the terminal 100 and is managed by a separate operator, the user may express his or her opinion on the information stored in the database 150 to the manager, and the manager may take into account the opinion and manage the database 150 in real-time.

The communication unit 160, according to an exemplary embodiment, performs wired or wireless communications with an external apparatus based on previously defined communication standards. Although such a communication unit 160 may be a wireless communication module such as a radio frequency (RF) module or the like, it is not limited thereto.

The control unit 170, according to an exemplary embodiment, may control data flow among the touch screen driving unit 110, the position data output unit 120, the input data acquisition unit 130, the input restriction unit 140, the database 150, and the communication unit 160. That is, the control unit 170 according to the present invention may control the touch screen driving unit 110, the position data output unit 120, the input data acquisition unit 130, the input restriction unit 140, the database 150, and the communication unit 160 in the performance of their respective functions.

Hereinafter, an example of the operation for preventing input of incorrect information when a user inputs information through a touch screen according to an exemplary embodiment will be described.

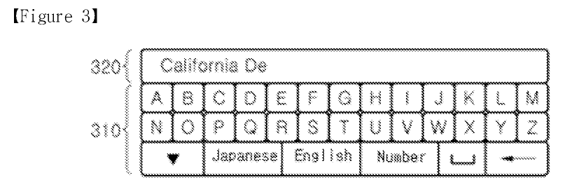

FIG. 3 is a view showing an example of a keypad 310 displayed on the display unit 111 of the terminal 100 having a touch screen according to an exemplary embodiment.

A user may input English letter information using the keypad 310 as shown in FIG. 3. If the terminal 100 is a navigator, the user may search for position information or the like by inputting a keyword including English letter information, numeric information, and the like.

A display window 320 for displaying data inputted up to the present by the user may be provided above the keypad 310.

If the user has inputted up to ‘California De’ using the keypad 310, the input restriction unit 140 searches the database 150 for information including the input data in real-time. If the database 150 stores ‘California Department store’, ‘California dental studio’, ‘California dermatology clinic’ and ‘California dental clinic’ as information that includes the input data and the database 150 stores ten or less pieces of information (where n is set to ten) that includes the data inputted up to the present, the input restriction unit 140 may inactivate the keys that may input incorrect information as the next input. Specifically, since there are four pieces of information including ‘California De’ in the database 150, the input restriction unit 140 may inactivate the keys that may input the information not stored in the database 150 as the next input of the user (i.e., all the keys except ‘n’, ‘p’, and ‘r’). In this case, if the user touches a key other than ‘n’, ‘p’, and ‘r’, a warning sound or message may be provided.

In this manner, a user can be guided to input effective data when inputting data through a touch screen. Furthermore, the user is protected from the inconvenience of manually deleting incorrect data and then inputting correct data when the user inputs incorrect data.

The aforementioned exemplary embodiments can be implemented in the form of a program command that can be executed through a variety of components of a computer and recorded in a computer readable medium. The computer readable medium may store program commands, data files, data structures, and the like in an independent or combined form. The program command recorded in the computer readable medium may be a command specially designed and constructed for the present invention or a command publicized to and used by those skilled in a computer software field. The computer readable medium may include, for example, magnetic media such as a hard disk, a floppy disk and a magnetic tape, optical recording media such as a CD-ROM and a DVD, magneto-optical media such as a floptocal disk, and a hardware device specially constructed to store and execute a program command, such as ROM, RAM, flash memory, and the like. The program command includes, for example, high-level language codes that can be executed by a computer using an interpreter or the like, as well as machine language codes created by a compiler. The hardware device may be constructed to operate as one or more software modules in order to perform the processing according to the present invention, and vice versa.

According to exemplary embodiments of the present invention, since input of incorrect information that does not exist in a database is restricted when the information is inputted through a variety of input interfaces provided in a terminal, it is easy to input correct information effectively.

Furthermore, according to exemplary embodiments of the present invention, since the function of restricting incorrect input can be applied to, for example, Korean characters, English letters, special characters, and numerals when information is inputted through an input interface of a terminal, a correct input can be induced in relation to all types of characters.

As described above, although the present invention has been described with reference to the limited exemplary embodiments and accompanying drawings and the specific matters such as the constitutional components, they are provided only for the purpose of understanding the present invention and the present invention is not limited to the exemplary embodiments.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of restricting input in association with a database, comprising:
searching a database for information that includes inputted data; and
restricting input of subsequent data that is not included in the information in the database that includes the inputted data,
wherein the inputted data comprises at least one grapheme.

2. The method of claim 1, wherein the inputted data comprises non-language related characters.

3. The method of claim 1, wherein restricting input of subsequent data comprises inactivating at least one key, wherein the at least one key corresponds to data that is not included in the information in the database that includes the inputted data.

4. The method of claim 3, further comprising providing a warning indication in response to selection of at least one of the at least one inactivated key.

5. The method of claim 4, wherein the warning indication comprises a warning sound or a warning message.

6. The method of claim 1, wherein restricting input of subsequent data only occurs if the number of pieces of information in the database that include the inputted data is n (n is an integer) or less.

7. The method of claim 1, wherein the inputted data is inputted through a terminal.

8. A processing apparatus for restricting input in association with a database, comprising:
an input data acquisition unit to acquire inputted data; and
an input restriction unit to search a database for information that includes the inputted data and to restrict input of subsequent data that is not included in the information in the database that includes the inputted data,
wherein the inputted data comprises at least one grapheme.

9. The apparatus of claim 8, wherein the inputted data comprises non-language related characters.

10. The apparatus of claim 8, wherein the input restriction unit inactivates at least one key, wherein the at least one key corresponds to data that is not included in the information in the database that includes the inputted data.

11. The apparatus of claim 10, wherein the input restriction unit provides a warning indication in response to selection of at least one of the at least one inactivated key.

12. The apparatus of claim 11, wherein the warning indication comprises a warning sound or a warning message.

13. The apparatus of claim 8, wherein the input restriction unit restricts input of subsequent data only if the number of pieces of information in the database that include the inputted data is n (n is an integer) or less.

14. The apparatus of claim 8, wherein the inputted data is inputted through a terminal.

15. A computer-readable medium comprising an executable program which, when executed, performs the steps of:
searching a database for information that includes inputted data; and
restricting input of subsequent data that is not included in the information in the database that includes the inputted data,
wherein the inputted data includes at least one grapheme.
